(19) United States
(12) Patent Application Publication
(10) Pub. No.: US 2009/0241032 A1
(43) Pub. Date: Sep. 24, 2009

(54) APPARATUS, SYSTEM, AND METHOD FOR UNIFORM RESOURCE LOCATOR SHARING

(76) Inventors: David Carroll Challener, Raleigh, NC (US); Justin Tyler Dubs, Durham, NC (US); Steven Richard Perrin, Raleigh, NC (US); Jennifer Greenwood Zawacki, Hillsborough, NC (US)

Correspondence Address: Kunzler & McKenzie, 8 EAST BROADWAY, SUITE 600, SALT LAKE CITY, UT, 84111, US

(21) Appl. No.: 12/050,813

(22) Filed: Mar. 18, 2008

(51) Int. Cl. G06F 3/048; G06F 15/16

(52) U.S. Cl. 715/751

(57) ABSTRACT

An apparatus, system, and method are disclosed for URL sharing. A link module links a plurality of user browsing sessions in a URL sharing session. A select module selects a user browsing session. A communication module communicates a URL for the selected user browsing session to each linked user browsing session. A display module displays the URL and corresponding web page of the selected user browsing session at each user browsing session.

### BACKGROUND OF THE INVENTION

1. Field of the Invention

This invention relates to Uniform Resource Locators (URL) and more particularly relates to URL Sharing.

2. Description of the Related Art

Online purchasing or shopping over the Internet is growing rapidly. When online shopping, a user typically browses web pages displaying items for sale, selects products or services, and completes purchases.

Traditional shopping is often a social experience. Shopping with others also tends to encourage purchases. In addition, shopping with others allows a shopper to get advice from knowledgeable friends and experts. However, online shopping is less of a social experience because of the difficulties of keeping multiple users on different computers together viewing the same web page.

### SUMMARY OF THE INVENTION

From the foregoing discussion, there is a need for an apparatus, system, and method that shares URLs. Beneficially, such an apparatus, system, and method would keep multiple users on different computers together viewing same web pages by sharing URLs.

The present invention has been developed in response to the present state of the art, and in particular, in response to the problems and needs in the art that have not yet been fully solved by currently available methods for URL sharing. Accordingly, the present invention has been developed to provide an apparatus, system, and method for URL sharing that overcome many or all of the above-discussed shortcomings in the art.

The apparatus to share a URL is provided with a plurality of modules configured to functionally execute the steps of linking a plurality of user browsing sessions, selecting a user browsing session, communicating a URL, and displaying the URL. These modules in the described embodiments include a link module, a select module, a communication module, and a display module.

The link module links a plurality of user browsing sessions in a URL sharing session. The select module selects a user browsing session. The communication module communicates a URL for the selected user browsing session to each linked user browsing session. The display module displays the URL and corresponding web page of the selected user browsing session to each user browsing session.

A system of the present invention is also presented to share URL. In particular, the system, in one embodiment, includes a network, a plurality of computers, and a portal server.

The plurality of computers is in communication with the network. The portal server is in communication with the computers through the network. The portal server comprises a link module, a select module, and a communication module.

The link module links a plurality of user browsing sessions executing on the computers in a URL sharing session. The select module selects a user browsing session. The communication module communicates a URL for the selected user browsing session to each linked user browsing session.

Each computer further comprises a display module. The display module displays the URL and corresponding web page of the selected user browsing session at each user browsing session.

A method of the present invention is also presented for URL sharing. The method in the disclosed embodiments substantially includes the steps to carry out the functions presented above with respect to the operation of the described apparatus and system. In one embodiment, the method includes linking a plurality of user browsing sessions, selecting a user browsing session, communicating a URL, and displaying the URL.

A link module links a plurality of user browsing sessions in a URL sharing session. A select module selects a user browsing session. A communication module communicates a URL for the selected user browsing session to each linked user browsing session. A display module displays the URL and corresponding web page of the selected user browsing session at each user browsing session. Thus the method would allow URL sharing among the plurality of users/shoppers.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention provides an apparatus, a system, and a method for URL sharing. Beneficially, such an apparatus, a system, and a method would allow the user/shopper to experience online shared shopping. Further, the apparatus, system, and method would allow displaying a plurality of tabs for the plurality of users and the URL and corresponding web page for the user browsing session of each tab. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a drawing illustrating one embodiment of a URL sharing system in accordance with the present invention;

FIG. 2 is a schematic block diagram illustrating one embodiment of a URL sharing apparatus of the present invention;

FIG. 3 is a drawing illustrating one embodiment of a display window of shared shopping of the present invention;

FIG. 4 is a drawing illustrating one embodiment of a display window for selecting a shopping buddy of the present invention;

FIG. 5 is a drawing illustrating one embodiment of a display window of shared shopping with the selected shopping buddy of the present invention;

FIG. 6 is a drawing illustrating one embodiment of a display window with a plurality tabs of the present invention;

FIG. 7 is a drawing illustrating one embodiment of a display window for shopping communication of the present invention; and

FIG. 8 is a schematic flow chart diagram illustrating one embodiment of a URL sharing method of the present invention.

### DETAILED DESCRIPTION OF THE INVENTION

Many of the functional units described in this specification have been labeled as modules, in order to more particularly emphasize their implementation independence. Modules may include hardware circuits such as one or more processors with memory, Very Large Scale Integration (VLSI) circuits, gate arrays, programmable logic, and/or discrete components. The hardware circuits may perform hardwired logic functions, execute computer readable programs stored on tangible storage devices, and/or execute programmed functions. The computer readable programs may in combination with a computer system perform the functions of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

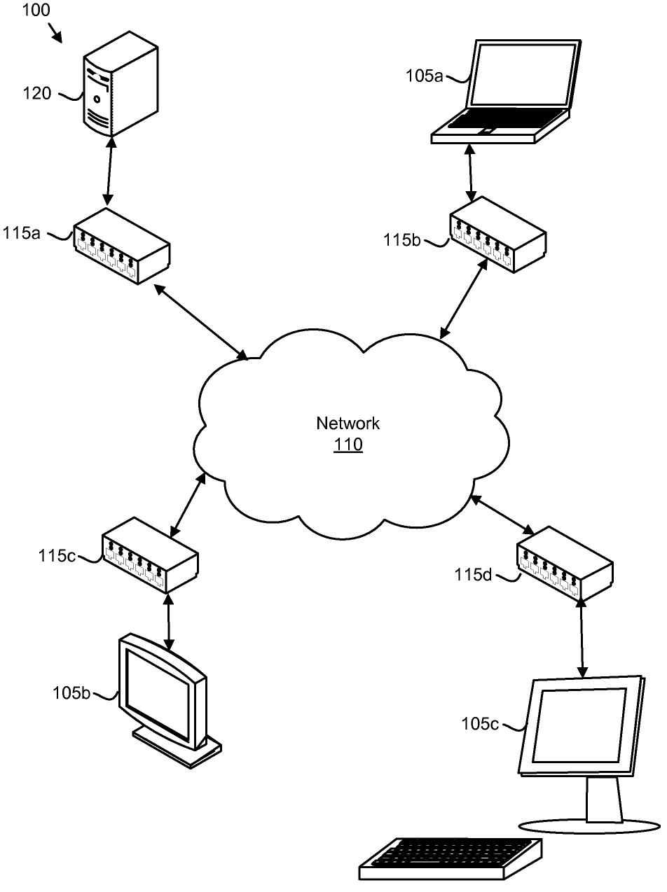

FIG. 1 is a drawing illustrating one embodiment of a URL sharing system 100 in accordance with the present invention. The system 100 includes a plurality of computers 105a-c, a plurality of routers 115a-d, a network 110, and a portal server 120. Although for simplicity, three (3) computers 105a-c, four (4) routers 115a-d, one portal server 120, and one network 110 are shown, any number may be employed in the system 100.

The network 110 may include a plurality of interconnected computer networks linked through copper wires/cables, fiber-optic cables, or the like, and/or wireless connections. For example, the network 110 may be selected from the Internet, an intranet, a wide area network (WAN), a local area network (LAN), an integrated services digital network (ISDN), or the like. The plurality of computers 105a-c is in communication with the network 110.

Each computer 105a-c and the portal server 120 may include one or more processor modules, one or more volatile memory modules, one or more non-volatile memory modules, one or more graphics modules, a north bridge module, a south bridge module, a basic input-output system (BIOS) module, one or more universal serial bus (USB) modules, one or more audio modules, one or more peripheral component interconnect (PCI) modules, one or more input and output devices, and the like referred to herein as components. These components may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The portal server 120 may also include a plurality of databases and a plurality of applications that constitute an online store containing items for sale from one or more vendors. The portal server 120 may also provide a framework and a set of software modules that may control functions such as security, mobility, identity-based content delivery, collaboration, business system integration, or the like of the data. For example, the portal server 120 may provide the framework and set of software modules that are designed to set up, operate, and integrate e-business applications across the plurality of computers 105a-d. The framework and set of software modules, computer program products, or the like may be tangibly stored in the storage modules of the plurality of computers 105a-c and the portal server 120.

The portal server 120 is in communication with the plurality of computers 105a-c through the network 110. Each router 115a-d may select a path over the network 110 to send a request for the data from the plurality of computers 105a-c to the portal server 120 and forward the data in the form of logically addressed packets from the portal server 120 to the plurality of computers 105a-c.

Each computer 105 may further include a screen selected form a cathode ray tube (CRT) screen, a liquid crystal display (LCD) screen, a thin film transistor (TFT) LCD screen, or the like. Additionally, each computer 105a-c may include a software framework that includes a web browser.

The web browser may be selected from a text based web browser such as Lynx or a graphical based web browser such as MICROSOFT INTERNET EXPLORER®, Mozilla Firefox, Apple Safari, NETSCAPE NAVIGATOR®, or the like. The web browser may automatically convert a plurality of HyperText Markup Language (HTML) codes in the form of corresponding text matter, one or more pictures/drawings, tables, hyperlinks, or the like and a display the created web page in an intended format on the screen of the one or more computers 105a-c as will be described hereinafter.

For purchasing a product online, the plurality of users of the computers 105a-c may browse a plurality of websites. For example, a first user of the first computer 105a may browse the website www.abcdef.com for purchasing a laptop computer.

A user browsing the website may be referred as a user browsing session in further description. The user browsing session may browse a number of related web pages on the same website or another websites. Each web page may have a unique URL. For example, the web page containing information such as different types of model available of the laptop computer, a cost of each model, specifications of each model, or the like may have the URL http://www.abcd.com/d_d/ref=nb_lenovo.

The web browser may locate the intended web page corresponding to the URL as is well known to those of skill in the art. The URL may be directed to a machine address using a method known to those skilled in the art.

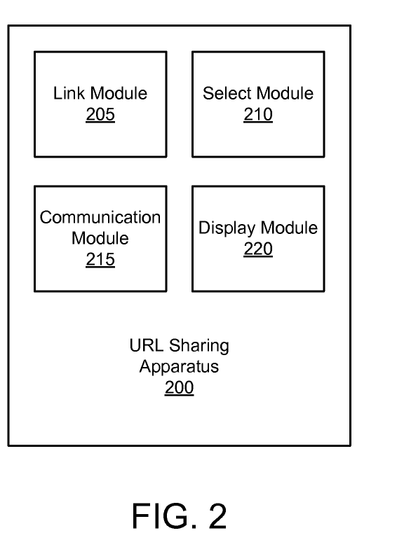

FIG. 2 is a schematic block diagram illustrating one embodiment of a URL sharing apparatus 200 of the present invention. The apparatus 200 enables URL sharing between multiple users/shoppers and can be embodied in the portal server 120 and/or the plurality of computers 105 of the FIG. 1. The description of apparatus 200 refers to elements of FIG. 1, like numbers referring to like elements. The apparatus 200 includes a link module 205, a select module 210, a communication module 215, and a display module 220.

The link module 205 links a plurality of user browsing sessions executing on the plurality of computers 105 in a URL sharing session. The select module 210 selects a user browsing session. The communication module 215 communicates a URL for the selected user browsing session to each linked user browsing session. The display module 220 displays the URL and corresponding web page of the selected user browsing session to each user browsing session. The link module 205, the select module 210, the communication module 215, and the display module 220 may be computer readable programs stored on a tangible storage device of the portal server 120 and/or the computers 105.

The link module 205 may further record a browsing history of each user browsing session. For example, the link module 205 may automatically record the browsing history that may comprise a plurality of URLs of each user browsing session in a file. The file that contains the recorded browsing history may be shared with other user browsing sessions. The link module 205 may further save the file on the hard disk drive of the user's computer 105.

The communication module 215 may communicate the browsing histories to the other user browsing sessions. For example, the communication module 215 may automatically communicate the browsing histories of rest of the user browsing sessions to the user that selects the shared file.

In an embodiment, the communication module 215 communicates secure information from the first user browsing session to the second user browsing session in response to a command from the first user browsing session. In an embodiment, the secure information comprises purchase payment information. For example, in response to the command from the first user browsing session, the communication module 215 may communicate the information for an online payment, such as details of a payment through Internet banking or a payment through a debit/credit card for purchasing a product such as a LENOVO® laptop, from the first user browsing session to the second user browsing session.

Alternatively, the secure information is a secure cookie. The secure cookie may comprise data such as a username login ID and a password. For example, in response to the command from the first user browsing session, the communication module 215 may communicate the secure cookie that contains the data such as the username login ID and the password of the first user for online payment for purchasing the LENOVO® laptop from the first user browsing session to the second user browsing session.

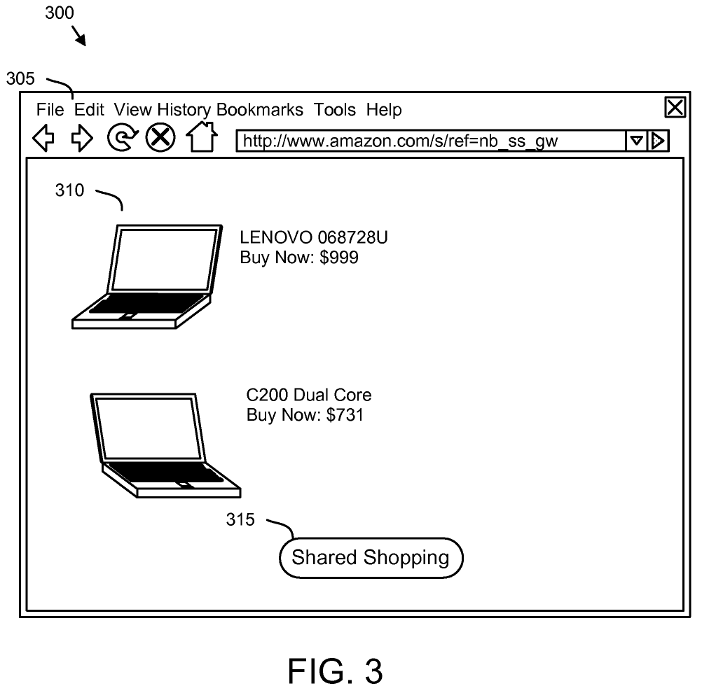

FIG. 3 is a drawing illustrating one embodiment of a display window 300 of shared shopping of the present invention. The description of window 300 refers to elements of FIGS. 1-2, like numbers referring to like elements. The window 300 includes a header portion 305 and a body portion 310. In one embodiment, the window 300 is illustrative of a user browsing session as presented to a user.

In the shown embodiment, the header portion 305 of the display window 300 includes a plurality of menus and command items as is well known to those of skill in the art. The body portion 310 includes two (2) products and a shared shopping interface 315. The two (2) products are shown as two (2) pictures of laptops. Each picture is further shown associated with a model name and a price.

In the shown embodiment, an address box of the header portion 305 displays a URL http://www.amazon.com/s/ref=nb_ss_gw. The address box may provide space for typing or pasting the URL. Further, the shared shopping interface 315 is shown configured at the bottom of the body potion 310 of the window 300. The shared shopping interface 315 may be configured as a user interface (UI) as is well known to those of skill in the art.

A user may install a shared shopping application on his/her computer 105. The installed shared shopping application may display the shared shopping interface 315 on a screen of the computer 105. The shared shopping application may comprise elements of the URL sharing apparatus 200. Alternatively, the shared shopping interface 315 may comprise HTML, Java, and the like code communicated from the portal 120. A selection of the shared shopping interface 315 may initiate the shared shopping session and URL sharing. For example, a mouse click on the shared shopping interface 315 may initiate the shared shopping session for the user.

The URL sharing apparatus 200 may or may not require user authentication. For example, the user may directly retrieve access to the shared shopping session when the user clicks the shared shopping interface 315.

Alternatively, the URL sharing apparatus 200 may require user authentication. For example, for first instance the user may require to input basic information such as a name, an email address, a security question, a preferred login username, a preferred password, or the like while registering for the shared shopping session. For example, the user may directly login to the shared shopping session with the registered username and password through a shared shopping login interface (not shown) as is well known to those of skill in the art.

In an embodiment, the user may add a URL to a shared bookmark list. For example, the user may add the URL http://www.amazon.com/s/ref=nb_ss_gw to the bookmark list of the menu ‘Bookmarks’ by a method well known to those of skill in the art. The bookmark list of the menu ‘Bookmarks’ may be shared. The communication module 210 may communicate the shared bookmark list to each userbrowsing session. For example, the communication module 210 may communicate the shared bookmark list to each user browsing session.

In response to a user command, the URL sharing apparatus 200 may add or remove the user browsing sessions. For example, the user may add or remove URLs of other user browsing sessions from the bookmark list of the menu ‘Bookmarks.’

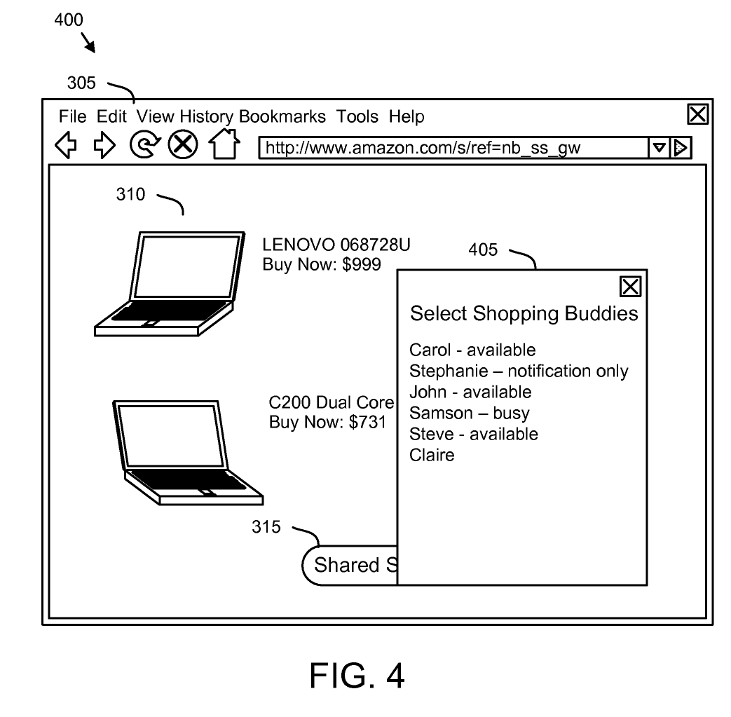

FIG. 4 is a drawing illustrating one embodiment of a display window 400 for selecting a shopping buddy of the present invention. The description of window 400 refers to elements of FIGS. 1-3, like numbers referring to like elements. The window 400 includes the header portion 305 and the body portion 310 of FIG. 3, and a shopper selection window 405.

The selection of the shared shopping interface 315 may further display the shopper selection window 405 in the body portion 310 of the window 400. In the shown embodiment, the shopper selection window 405 includes a title ‘Select Shopping Buddies’ and a plurality of list items. Each list item is shown including a name of an individual or a group and a shared shopping status. Each list item may be configured as a UI.

Each name of the individual or the group may indicate the availability of the individual or the group registered for the shared shopping. The link module 205 may also register the user browsing session with the shared shopping status with a server such as the portal server 120 and/or a coordinating server. The shared shopping status may indicate a status such as ‘available,’ ‘not available,’ ‘busy,’ or the like depending on the availability of the individual or the group for online shared shopping. Each individual or group may be referred as a shopping buddy in further description.

In the shown embodiment, the shopper selection window 405 includes the name of the individuals or the groups such as ‘Carol’, ‘John’, and ‘Steve’ with the shared shopping status of ‘available’, ‘Samson’ with the shared shopping status of ‘busy’, ‘Stephanie’ with the shared shopping status of ‘notification only’, and ‘Claire’ with the shared shopping status of ‘not available.’ The user may select the user browsing sessions of one or more individuals or groups from the list of the shopping buddies by selecting the name of the individual or the group depending on the individual's or group's availability for the online shared shopping. For example, the user may select the list item ‘Carol available’ to select the user browsing session of the shopping buddy ‘Carol.’ In addition, the user may click the list item ‘John available’ to select the user browsing session of the shopping buddy ‘John.’

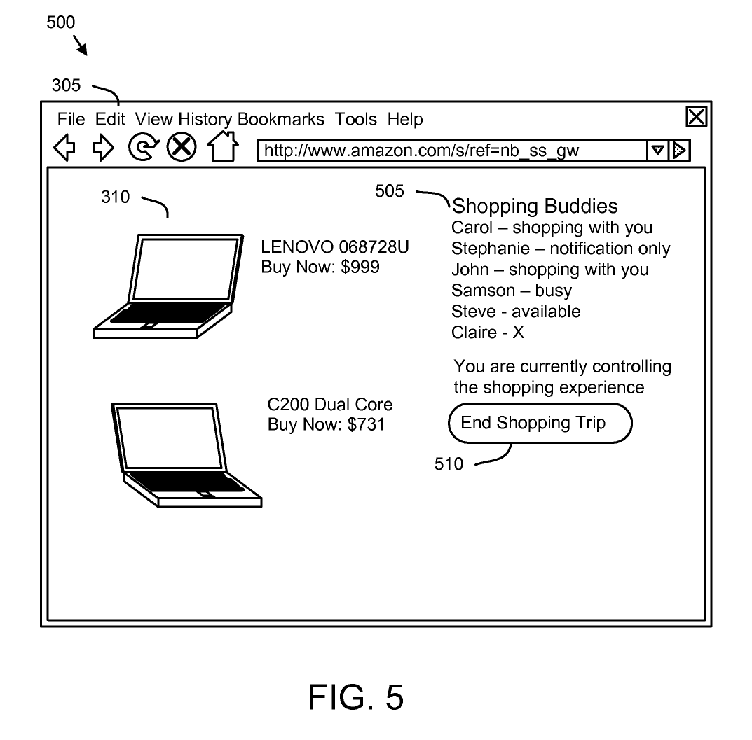

FIG. 5 is a drawing illustrating one embodiment of a display window 500 of shared shopping with the selected shopping buddy of the present invention. The description of window 500 refers to elements of FIGS. 1-4, like numbers referring to like elements. The window 500 includes the header portion 305, the body portion 310 of FIG. 3, a shopping buddy list 505, and an end shopping trip interface 510.

The shared shopping application may automatically display the list 505 and the end shopping trip interface 510 when the user completes selection of one or more shopping buddies depending upon the availability of the individual or the group for the shared shopping. The end shopping trip interface 510 may be configured as a UI. The user may terminate the shared shopping session by selecting the end shopping trip interface 510.

In an embodiment, the link module 205 designates a first user browsing session as a leader browsing session. For example, the link module 205 may designate the first user browsing session on the first computer 105 as the leader browsing session. The leader browsing session may control the shared shopping session and URL sharing. In the shown embodiment, the list is accompanied with a message ‘you are currently controlling the shopping experience.’ The displayed message may indicate that the user is designated as the first user. One of skill in the art that other indicators of a leader browsing session may be employed.

The display module 220 may display a URL and a web page viewed by the leader browsing session for each user browsing session. For example, the display module 220 may display the URL http://www.amazon.com/s/ref=nb_ss_gw and the web page viewed by the first user browsing session for user browsing sessions of the second and third user.

In an embodiment, the link module 205 may record a browsing history of the leader and communicate the browsing history to the other user browsing sessions. For example, the link module 205 may automatically record the browsing history that may comprise the plurality of URLs of the site of the site www.lenovo.com/us designated expert browsing session configured as the first user in a file for purchasing a LENOVO® laptop. The leader may be a web site designated expert browsing session. For example, the link module 205 may link a user browsing session to an expert browsing session at a laptop computer web site. The expert browsing session may lead the user to selecting laptop computer.

The link module 205 may further designate a second user browsing session as the leader in response to a user command. For example, in response to the first user command the link module 205 may further designate the second user browsing session as the leader. Subsequently the second user browsing session may control the shopping experience.

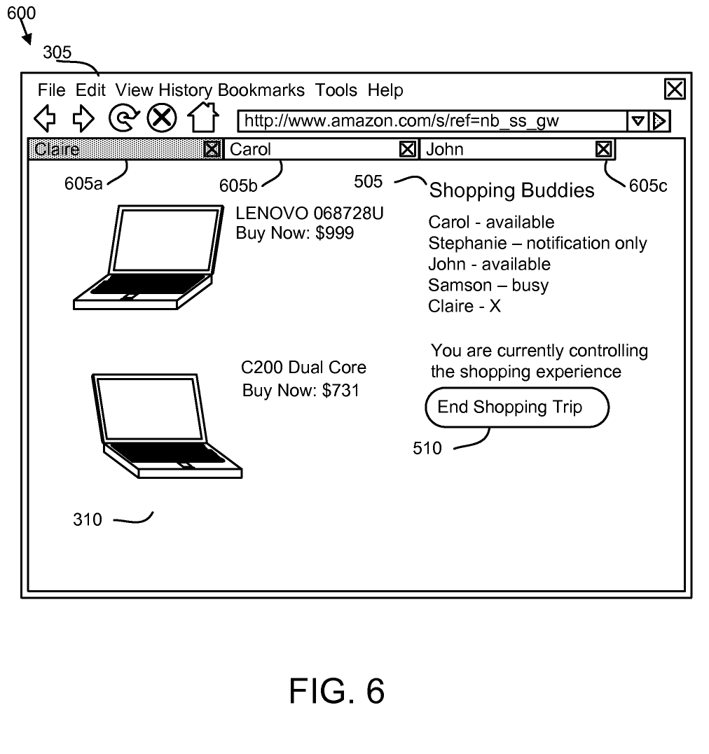

FIG. 6 is a drawing illustrating one embodiment of a display window 600 for displaying a plurality of tabs of the present invention. The description of window 600 refers to elements of FIGS. 1-5, like numbers referring to like elements. The window 600 includes the header portion 305 and the body portion 310 of FIG. 3, the list 505 of shopping buddies and the interface 510 to end a shopping trip of FIG. 5, and a plurality of tabs 605a-c.

The display module 220 may display a tab 605 for each linked user browsing session. Each tab 605a-c may be configured as a text label as is well known to those of skills in the art. In the shown embodiment, the display module 220 displays a first tab 605a for the linked user browsing session of ‘Claire’, a second tab 605b for the linked user browsing session of ‘Carol’, and a third tab 605c for the linked user browsing session of ‘John.’

Further, the first tab 605a for the linked user browsing session of ‘Claire’ is shown shaded. The shaded tab may indicate that the user browsing session of the shopping buddy is designated as the leader browsing session.

In response to selecting the tab 605 for the user browsing session, the display module 220 may display a URL and corresponding web page viewed by the user browsing session. For example, when the user selects the tab 605 or directs the user browsing session to activate the tab 605 by a mouse click, the display module 220 may display the URL and corresponding web page viewed by the user browsing session. In a particular example, when the user selects the second tab 605b for the user browsing session of the shopping buddy ‘Carol’ to activate the tab 605 by the mouse click, the display module 220 may display the URL http://www.amazon.com/s/ref=nb_ss_gw and corresponding web page viewed by the user browsing session of the shopping buddy ‘Carol.’

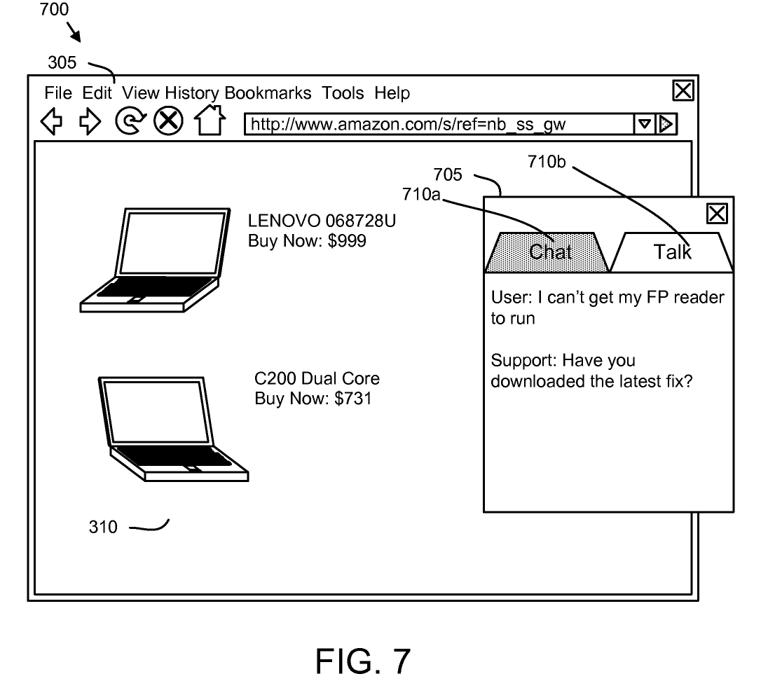

FIG. 7 is a drawing illustrating one embodiment of a display window 700 of shopping communication of the present invention. The description of window 700 refers to elements of FIGS. 1-6, like numbers referring to like elements. The window 700 includes the header portion 305, the body portion 310 of FIG. 3, and a communication window 705.

In response to a user command, the display module 220 may automatically display the communication window 705. In the shown embodiment, the communication window 705 includes a first communication interface 710a with a label ‘Chat’ and a second communication interface 710b with a label ‘Talk.’ Although for simplicity, two (2) communication interfaces are shown, any number may be employed in the communication window 705.

The communication interface 710 may be configured as a UI. In the shown embodiment, the first communication interface 710a is shown shaded. The shaded communication interface 710a may indicate a selection of the communication interface 710. For example, the selection of the communication interface 710 may allow the user to communicate with other linked users during the shared shopping session. Alternatively, the communication interface 710 may allow the user to communicate with customer care personnel that may provide a post purchase support for the product.

In an embodiment, the communication interface 710 is configured as a text communication interface. The first communication interface 710a with the label ‘Chat’ may be the text communication interface. The first communication interface 710a may allow each user to type messages using the keyboard of the computer 105 and further send the typed to the other users. Additionally, the first communication interface 710a may receive the messages from the other users and display the received messages on the screen of the computer 105.

Alternatively, the communication interface 710 may be a voice communication interface. In one more embodiment, the communication interface 710 is configured as a video communication interface. The communication interface 710 may establish communication between the plurality of users as is well known to those of skill in the art.

The selection of the communication interface 710 for example, may initiate an online chat, a verbal conversation using microphones or telephones, or a video conferencing of the user that selects the communication interface 710 with other users in the shared shopping session or with the executive of the customer care. In the depicted embodiment, the chat between the user and a support personnel is shown.

The schematic flow chart diagram that follows is generally set forth as logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

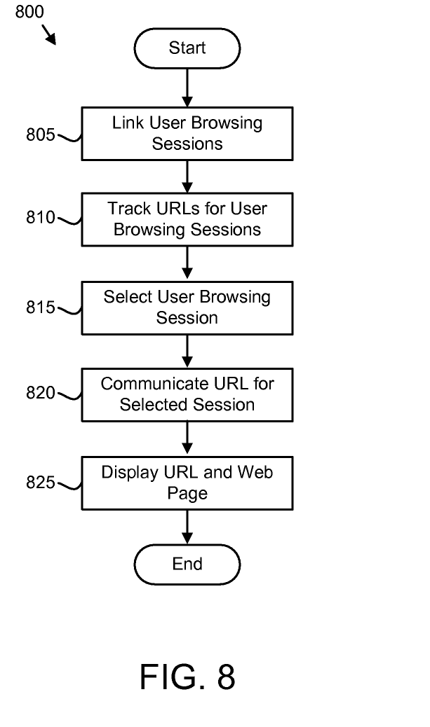

FIG. 8 is a schematic flow chart diagram illustrating one embodiment of a URL sharing method 800 of the present invention. The method 800 substantially includes the steps to carry out the functions presented above with respect to the operation of the described system 100 of FIG. 1, apparatus 200 of FIG. 2, and display windows 300-700 of FIGS. 3-7. The description of method 800 refers to elements of FIGS. 1-7, like numbers referring to the like elements. In one embodiment, the method is implemented with a computer program product comprising a computer readable medium having a computer readable program. The computer readable program may be on the portal server 120 and/or a computer 105.

The method 800 begins, and in an embodiment, the link module 205 links 805 a plurality of user browsing sessions in a URL sharing session. For example, the link module 205 may automatically link 805 the browsing session of the first user browsing session on the first computer 105a, the second user browsing session on the second computer 105b, the third user browsing session on the third computer 105c, in the URL sharing session transmitting over the Internet.

In an embodiment, the link module 305 initiates the link of the plurality of user browsing sessions from a web page. For example, the link module 305 may automatically initiate the link of the plurality of user browsing sessions from the web page when the user clicks the shared shopping interface 315.

Alternatively, the link module 305 may initiate the link of the plurality of user browsing sessions from a selection of a shared tab 605. For example, when each user clicks the shared tab 605, the link module 305 may automatically initiate the link of the plurality of user browsing sessions.

In an embodiment, the link module 205 links 805 the plurality of user browsing sessions at a portal. Continuing with the above example, the link module 205 may automatically link 805 the browsing session of the first, second, third and/or the browsing sessions of individuals or groups such as ‘Carol’, ‘Stephanie’, ‘John’, ‘Samson’, ‘Steve’, and ‘Claire’ from the shopper selection window 405 at the portal server 120.

The link module 205 may further track 810 URLs for the user browsing sessions. In a particular embodiment, the link module 205 records each shared URL and at least one shared user browsing session of the URL. For example, the link module 305 may track 810 URLs for the browsing sessions of the first, second, third and/or the browsing sessions.

The select module 210 selects 815 the user browsing session. For example, the user browsing session that initiates URL sharing may be selected. In one embodiment, the selected user browsing session is designated as a leader browsing session. Additionally, when the first user clicks the list item ‘John available’ of the shopper selection window 405, the select module 210 may select 815 the user browsing session of the individual or group designated by ‘John’ in the shopper selection window 405.

The communication module 215 communicates 820 a URL for the selected user browsing session to each linked user browsing session. For example, the communication module 215 may communicate 820 the URL for the user browsing session of the individual or group ‘Carol’ to the user browsing session of the first, second, third, and/or the other user browsing sessions.

The display module 220 displays 825 the URL and corresponding web page of the selected user browsing session to each user browsing session. For example, the display module 220 may display 825 the URL and corresponding web page of the of the individual or group ‘Carol’ to the user browsing session of the first, second, and third user browsing sessions. Thus the method would allow URL sharing among the plurality of users/shoppers.

The present invention provides an apparatus, a system, and a method for URL sharing. Beneficially, such an apparatus, a system, and a method would allow the user/shopper to experience online shared shopping. Further, the apparatus, system, and method would allow displaying a plurality of tabs 605 for the plurality of users and the URL and corresponding web page for each user browsing session. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer useable medium having a computer readable program stored on a tangible storage device, wherein the computer readable program when executed on a computer causes the computer to:
link a plurality of user browsing sessions in a Uniform Resource Locator (URL) sharing session;
select a user browsing session;
communicate a URL for the selected user browsing session to each linked user browsing session; and
display the URL and corresponding web page of the selected user browsing session to each user browsing session.

2. The computer program product of claim 1, wherein the computer readable program is further configured to cause the computer to:
display a tab for each linked user browsing session; and
display a URL and corresponding web page viewed by a user browsing session in response to selecting a tab for the user browsing session.

3. The computer program product of claim 1, wherein the computer readable program is further configured to cause the computer to link the plurality of user browsing sessions at a portal.

4. The computer program product of claim 1, wherein the computer readable program is further configured to cause the computer to designate a first user browsing session as a leader browsing session.

5. The computer program product of claim 4, wherein the computer readable program is further configured to cause the computer to display a URL and a web page viewed by the leader browsing session for each user browsing session.

6. The computer program product of claim 5, wherein the leader browsing session is a site designated expert browsing session.

7. The computer program product of claim 4, wherein the computer readable program is further configured to cause the computer to designate a second user browsing session as the leader browsing session in response to a user command.

8. The computer program product of claim 4, wherein the computer readable program is further configured to cause the computer to record a browsing history of the leader browsing session and communicate the browsing history to the other user browsing sessions.

9. The computer program product of claim 1, wherein the computer readable program is further configured to cause the computer to record a browsing history of each user browsing session and communicate the browsing histories to the other user browsing sessions.

10. The computer program product of claim 1, wherein the computer readable program is further configured to cause the computer to communicate secure information from a first user browsing session to a second user browsing session in response to a command from the first user browsing session.

11. The computer program product of claim 10, wherein the secure information is a secure cookie.

12. The computer program product of claim 10, wherein the secure information comprises purchase payment information.

13. The computer program product of claim 1, wherein the computer readable program is further configured to cause the computer to provide a text communication interface.

14. The computer program product of claim 1, wherein the computer readable program is further configured to cause the computer to provide a voice communication interface.

15. The computer program product of claim 1, wherein the computer readable program is further configured to cause the computer to provide a video communication interface.

16. The computer program product of claim 1, wherein the computer readable program is further configured to cause the computer to record each shared URL and at least one shared user browsing session of the URL.

17. The computer program product of claim 1, wherein the computer readable program is further configured to cause the computer to add a URL to a shared bookmark list and communicate the shared bookmark list to each linked user browsing session.

18. The computer program product of claim 1, wherein the computer readable program is further configured to cause the computer to add and remove user browsing sessions in response to a user command.

19. The computer program product of claim 1, wherein the computer readable program is further configured to cause the computer to initiate the linking of the plurality of user browsing sessions from a web page.

20. The computer program product of claim 1, wherein the computer readable program is further configured to cause the computer to create a shared tab and initiate the link of the plurality of user browsing sessions from the shared tab.

21. An apparatus comprising:
a link module configured to link a plurality of user browsing sessions in a URL sharing session;
a select module configured to select a user browsing session;
a communication module configured to communicate a URL for the selected user browsing session to each linked user browsing session; and
a display module configured to display the URL and corresponding web page of the selected user browsing session to each user browsing session.

22. A system comprising:
a network;
a plurality of computers in communication with the network;
a portal server in communication with the computers through the network and comprising
a link module configured to link a plurality of user browsing sessions executing on the computers in a URL sharing session;
a select module configured to select a user browsing session;
a communication module configured to communicate a URL for the selected user browsing session to each linked user browsing session; and
each computer further comprising
a display module configured to display the URL and corresponding web page of the selected user browsing session to the user browsing session.
